(19) United States
(12) Patent Application Publication
(10) Pub. No.: US 2008/0178741 A1
(43) Pub. Date: Jul. 31, 2008

(54) Coffee maker with CD, DVD and MP3 player

(76) Inventors: Robert DeMars, LaQuinta, CA (US); Dan M. DeLaRosa, New York, NY (US)

Correspondence Address: Dan M. DeLaRosa, Esq., Suite 24C, 300 E 77th Street, New York, NY, 10021, US

(21) Appl. No.: 11/699,790

(22) Filed: Jan. 31, 2007

(51) Int. Cl. A47J 31/02; A47J 31/00; G08B 21/00; H04N 5/00

(52) U.S. Cl. 99/282; 340/606; 386/126; 99/290

(57) ABSTRACT

A coffee making and music or movie playing apparatus is provided, the apparatus comprising: a housing comprising a water reservoir and a brewing station; a container for receiving the brewed coffee; a compact disc player and/or an MP3 player and/or a DVD, and at least one speaker; and a sensor that senses when the coffee starts to brew and activates said compact disc player to start playing music or movie.

### BACKGROUND OF THE INVENTION

1. Field of the Invention

This invention relates to a coffee making and music or movie playing apparatus comprising: a housing comprising a water reservoir and a brewing station; a container for receiving the brewed coffee; a compact disc player and/or an MP3 player and/or a DVD, and at least one speaker; and a sensor that senses when the coffee starts to brew and activates said compact disc player to start playing music.

2. Description of the Related Art

There are various coffee makers with added features and numerous appliances with automatic temperature responsive devices that are used with cooking and brewing. U.S. Pat. No. 3,226,528 relates to a coffee brewing device with a music box and a thermally responsive system. U.S. Pat. No. 4,102,294 relates to a coffee pot with a perk alarm to indicate when the coffee has been brewed. U.S. Pat. No. 4,133,256 relates to a device for making hot drinks with an alarm which actuates when the drink is ready and continues until the cup is removed from the device. U.S. Pat. No. 4,572,060 relates to an automatic coffee boiler with feeding device. U.S. Pat. No. 4,735,191 relates to a musical tea kettle device. U.S. Pat. No. 4,857,897 relates to an electronic teapot with a boiling point musical alarm. U.S. Pat. No. 5,694,115 relates to a remote control activated coffee maker.

Unlike the prior art references, the present invention provides for a coffee maker with a compact disc player, an MP3, a dvd and a retractable screen. In addition, the present invention provides for brewing device that activates either the compact disc player, the mp3 or the dvd player when the water is boiling or the coffee has brewed and there is also a rheostat which controls an increase in the volume as the water boils or the coffee brews.

### SUMMARY OF THE INVENTION

In one embodiment, the present invention provides for a coffee making and music playing apparatus comprising: a housing comprising a water reservoir and a brewing station; a container for receiving the brewed coffee; a compact disc player and at least one speaker; and a sensor that senses when the coffee starts to brew and activates the compact disc player to start playing music.

In another embodiment, the apparatus further comprises an MP3 player. In still another embodiment, the apparatus further comprises a rheostat; the rheostat is connected to the apparatus whereby the rheostat controls how the music increases in volume as the coffee is being brewed and upon completion of the brewing process, the volume is set a certain volume. In yet another embodiment, the apparatus further comprises controls for controlling the function of the compact disc player.

In still yet another embodiment, the apparatus further comprises a DVD player and at least one screen. In a further embodiment, the screen is connected to the housing. In another further embodiment, the screen is a sliding screen or a pop-up screen.

In still a further embodiment, the apparatus further comprises a water supply conduit for connecting the reservoir and the brewing station. In yet a further embodiment, the apparatus further comprises a wireless remote control, a timer, a radio, an alarm and a clock. In still yet a further embodiment, the brewing station comprises a base heater and the container is designed to sit atop the base heater.

In another embodiment, the present invention relates to a coffee making and music playing apparatus comprising: a housing comprising a water reservoir and a brewing station; a container for receiving the brewed coffee; an MP3 player and at least one speaker; and a sensor that senses when the coffee starts to brew and activates said MP3 player to start playing music.

In a further embodiment, the present invention relates to a coffee making and movie playing apparatus comprising: a housing comprising a water reservoir and a brewing station; a container for receiving the brewed coffee; a DVD player, at least one screen and at least one speaker; and a sensor that senses when the coffee starts to brew and activates the DVD player to start playing movies.

In another further embodiment, the sensor of the present invention is activated by the boiling temperature of the liquid or the steam or vapor emitted by the liquid when it is boiling.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is a perspective view of one of the embodiments of the coffee making and music playing apparatus of the present invention;

FIG. 2 is a perspective view of FIG. 1 with a sliding screen; and

FIG. 3 is a perspective view of FIG. 1 with a pop-up screen.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessary to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

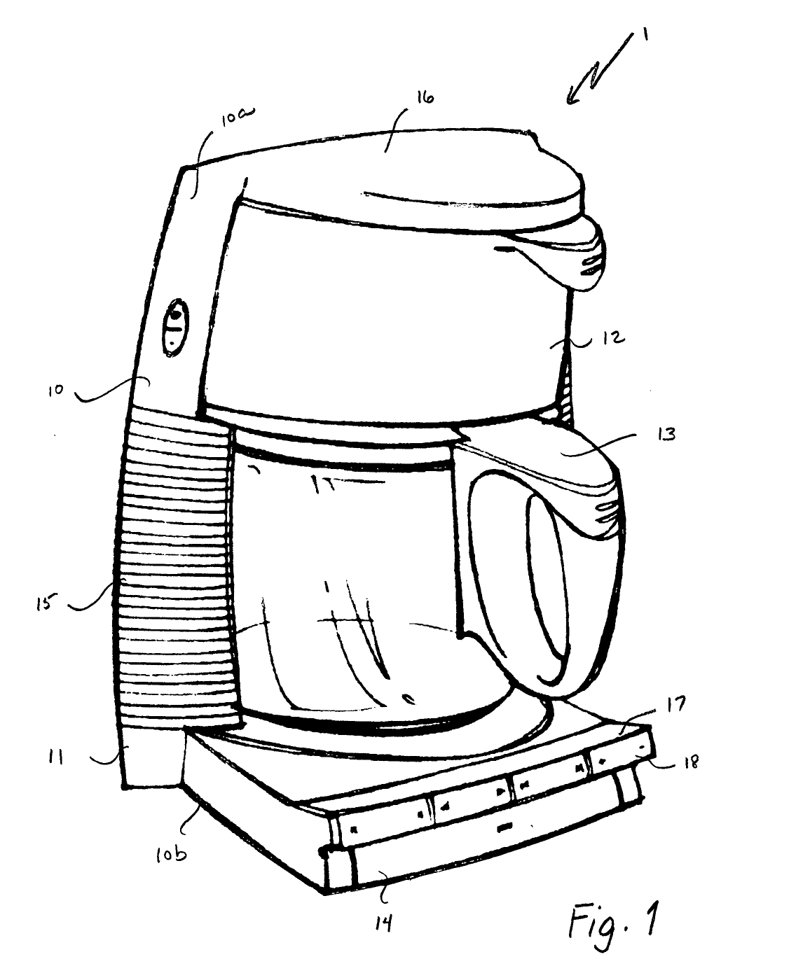

FIG. 1 depicts one embodiment of the invention wherein a coffee making apparatus 1 is provided. The apparatus 1 comprises a housing 10 with a water reservoir 11 and a brewing station 12; a container 13 for receiving the brewed coffee; a compact disc player 14 and at least one speaker 15; and a sensor that senses when the coffee starts to brew and activates said compact disc player 14 to start playing music. The housing 10 has a top portion 10a and the top portion 10a has a removable lid 16 which provides for an opening to the water reservoir 11. The bottom portion 10b of the housing 10 contains a panel 17 with buttons 18 to activate and program the compact disc player 14, an alarm and the settings.

The apparatus 1 of the present invention further comprises an MP3 player and a rheostat. The rheostat is connected to the apparatus 1 whereby the rheostat controls how the music increases in volume as the coffee is being brewed and upon completion of the brewing process, the volume is set a certain volume.

The apparatus 1 the apparatus further comprises a water supply conduit for connecting the reservoir 11 and the brewing station 12. The apparatus further comprises a wireless remote control, a timer, a radio, an alarm and a clock. The brewing station 12 comprises a base heater and the container 13 is designed to sit atop the base heater.

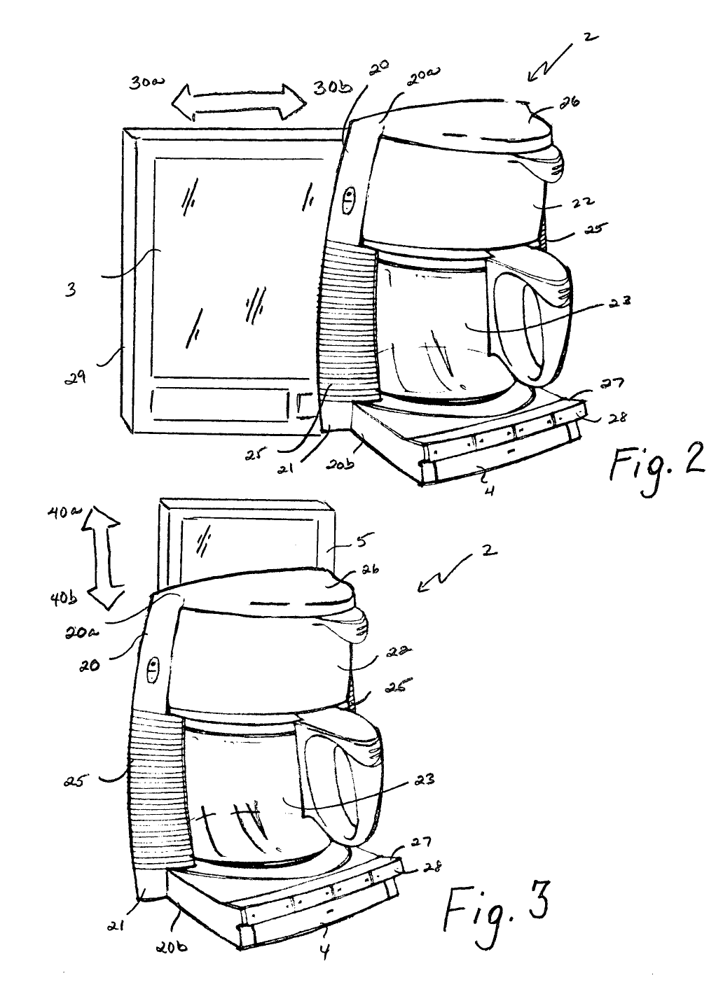

FIG. 2 relates to another embodiment of the present invention which provides a coffee making apparatus 2 with a retractable sliding screen 3 and a dvd player 4. The apparatus 1 comprises a housing 20 comprising a water reservoir 21 and a brewing station 22; a container 23 for receiving the brewed coffee; a dvd player 4, a screen 3 and at least one speaker 25; and a sensor that senses when the coffee starts to brew and activates the dvd player 4 to start playing a movie. The housing 20 has a top portion 20a and the top portion 20a has a removable lid 26 which provides for an opening to the water reservoir 21. The bottom portion 20b of the housing 20 contains a panel 27 with buttons 28 to activate and program the dvd player 4, an alarm and the settings. The tv screen 3 is covered by a tv housing 29 and has a locking mechanism which allows the screen 3 to be a use position 30a and a closed, non-use position 30b.

FIG. 3 relates to another embodiment of FIGS. 1-2 wherein there is a retractable pop-up screen 5 with the dvd player 4. The housing 20 has an extended back portion for holding the screen 5 and an ejection mechanism for popping up the screen 5 during a use position. The housing also has a locking mechanism which allows the screen 5 to be in a use position 40a and a closed, non-use position 40b. The housing 20 also provides for a port for holding an MP3 player. The tv screen is HD capable and the apparatus 2 can be connected to a cable box and the user can watch television and cable on the screens 3 and 5. The rear of the housing 20 can have the necessary connection capabilities for these additional functions.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A coffee making and music playing apparatus comprising:
a housing comprising a water reservoir and a brewing station;
a container for receiving the brewed coffee;
a compact disc player and at least one speaker; and
a sensor that senses when the coffee starts to brew and activates said compact disc player to start playing music.

2. The apparatus of claim 1 further comprises an MP3 player.

3. The apparatus of claim 1 further comprises a rheostat, said rheostat being connected to said apparatus whereby said rheostat controls how the music increases in volume as the coffee is being brewed and upon completion of the brewing process, the volume is set a certain volume.

4. The apparatus of claim 1 further comprises controls for controlling the function of said compact disc player.

5. The apparatus of claim 1 further comprises a DVD player.

6. The apparatus of claim 1 further comprises at least one screen.

7. The apparatus of claim 6 wherein said screen is connected within said housing.

8. The apparatus of claim 6 wherein said screen is a sliding screen.

9. The apparatus of claim 6 wherein said screen is a pop-up screen.

10. The apparatus of claim 1 further comprises a water supply conduit for connecting said reservoir and said brewing station.

11. The apparatus of claim 1 further comprises a wireless remote control, a timer, a radio, an alarm and a clock.

12. The apparatus of claim 1 wherein said brewing station comprises a base heater and said container is designed to sit atop said base heater.

13. A coffee making and music playing apparatus comprising:
a housing comprising a water reservoir and a brewing station;
a container for receiving the brewed coffee;
an MP3 player and at least one speaker; and
a sensor that senses when the coffee starts to brew and activates said MP3 player to start playing music.

14. The apparatus of claim 13 further comprises a memory bank for holding music for said MP3 player.

15. The apparatus of claim 13 further comprises a rheostat, said rheostat being connected to said apparatus whereby said rheostat controls how the music increases in volume as the coffee is being brewed and upon completion of the brewing process, the volume is set a certain volume.

14. The apparatus of claim 13 further comprises a water supply conduit for connecting said reservoir and said brewing station.

15. The apparatus of claim 13 further comprises a wireless remote control, a timer, a radio, an alarm and a clock.

16. The apparatus of claim 13 wherein said brewing station comprises a base heater and said container is designed to sit atop said base heater.

17. A coffee making and movie playing apparatus comprising:
a housing comprising a water reservoir and a brewing station;
a container for receiving the brewed coffee;
a DVD player, at least one screen and at least one speaker; and
a sensor that senses when the coffee starts to brew and activates said DVD player to start playing movie.

18. The apparatus of claim 17 further comprises a rheostat, said rheostat being connected to said apparatus whereby said rheostat controls how the music increases in volume as the coffee is being brewed and upon completion of the brewing process, the volume is set a certain volume.

19. The apparatus of claim 17 wherein said screen is a television screen.

20. The apparatus of claim 17 further comprises a wireless remote control, a timer, a radio, an alarm and a clock.
